(19) United States
(12) Patent Application Publication
(10) Pub. No.: US 2021/0134384 A1
(43) Pub. Date: May 6, 2021

(54) SYSTEM-IN-PACKAGE (SiP) ASSEMBLY

(71) Applicant: Changxin Memory Technologies, Inc., Hefei (CN)

(72) Inventor: Shu-Liang NING, Hefei (CN)

(21) Appl. No.: 17/144,358

(22) Filed: Jan. 8, 2021

Related U.S. Application Data
(63) Continuation of application No. PCT/CN2019/093841, filed on Jun. 28, 2019.

(30) Foreign Application Priority Data
Jul. 11, 2018 (CN) 201810757901.3

(51) Int. Cl. G11C 29/38; G11C 29/14; G11C 11/00

(52) U.S. Cl. CPC G11C 29/38; G11C 11/005; G11C 29/14

(57) ABSTRACT

A system-in-package (SiP) assembly is disclosed, which comprises: a dynamic memory; a non-volatile memory configured to store a scrambling algorithm for the dynamic memory; and a logic processor connected to the dynamic memory and the non-volatile memory. The logic processor is configured to generate test information, scramble the test information based on the scrambling algorithm stored in the non-volatile memory and transmit the scrambled test information to the dynamic memory. The dynamic memory, the non-volatile memory, and logic processor are integrated and packaged in a single package.

### CROSS-REFERENCE TO RELATED APPLICATIONS

This application is a continuation application of International Patent Application No. PCT/CN2019/093841, filed on Jun. 28, 2019, which is based on and claims priority to and benefits of Chinese Patent Application No. 201810757901.3, filed with the State Intellectual Property Office (SIPO) of the People's Republic of China on Jul. 11, 2018. The entire contents of all the above-identified applications are incorporated herein by reference.

### TECHNICAL FIELD

The present invention relates to the field of integrated circuits, and in particular, to a system-in-package (SiP) assembly.

### BACKGROUND

With the increase of product functionalities and decrease of product size, the integration of components in a system is an important technology in the development of communication and information electronic products. Currently, system on chip (SoC) and system-in-package (SiP) are the two technologies that received the most attentions, and the SoC is considered to be crucial for the design of electronic products in the future. While SoC is still being developed, SiP may be adopted by many manufacturers as an alternative to effectively reduce the product size with less financial and technological risks, as the low-cost SiP also focuses on compactness, high frequencies, high speeds, and short manufacturing cycles.

In the design of a high-speed digital components, it is often necessary to integrate a SoC device with a memory. For example, a graphics processing unit (GPU) is a SiP integrating a graphics control integrated circuit (IC) and a dynamic random access memory (DRAM) into a single package. This can not only reduce the footprint and design complexity of the GPU, but also reduce the delays of the graphics control IC in reading signals, which can help to achieve high-speed performance.

As shown in FIG. 1A, a memory 110 and a SoC device 100A are integrated in a SiP device 100. Thus, it may be difficult to access the data in the memory 110 externally for testing purposes. For this reason, deploying a memory built-in self-test (MBIST) system 130C in the SoC device 100A, specifically in a memory controller 130 in the SoC device 100A, is a common approach to test the memory 110, and built-in self-test (BIST) diagnostics or reconciling error lines can be performed for the memory 110.

In order to effectively test the memory, data are typically written in the memory based on their physical addresses. However, on the one hand, due to the effect of address scrambling algorithms, logical addresses provided by the MBIST system 130C may not match the physical addresses of the memory 110 exactly, as shown in FIG. 1C. Specifically, in complex memory designs, data scrambling algorithms may cause inconsistencies between data requested to be written by the MBIST system 130C and data actually written in the memory 110. For example, a test request from the MBIST system 130C is to write the datum “0” into the logical address “0”. However, in the memory 110, the datum actually written into the physical address corresponding to the logical address “0” of a memory array 111 may be “1”, as shown in FIG. 1B. This may result in a testing error.

On the other hand, scrambler circuit designs in memories from different manufacturers may be different. The built-in diagnostics test pattern of MBIST lacks versatility and compatibility. Therefore, there is a need for a solution that can address MBIST test requirements of different memories from different manufacturers.

It should be noted that the above disclosure in this Background section should not be taken as an acknowledgement that the information is part of the prior art or is common knowledge for those skilled in the art.

### SUMMARY OF THE INVENTION

In embodiments of the present invention, a system-in-package (SiP) assembly is provided to address or mitigate one or more of the above problems.

In one aspect, embodiments of the present invention discloses a SiP assembly, comprising: a dynamic memory; a non-volatile memory configured to store a scrambling algorithm for the dynamic memory; and a logic processor connected to the dynamic memory and the non-volatile memory, and the logic processor configured to generate test information, scramble the test information based on the scrambling algorithm stored in the non-volatile memory, and transmit the scrambled test information to the dynamic memory, wherein the dynamic memory, the non-volatile memory, and the logic processor are integrated and packaged in a single package.

In one of the embodiments, the test information may comprise an address, wherein the scrambling algorithm comprises an address scrambling algorithm, and the logic processor is configured to scramble the address based on the address scrambling algorithm and transmit the scrambled address to the dynamic memory.

In one of the embodiments, the logic processor may comprise: an address pattern generator for generating the address; and an address scrambler comprising a programmable logic array connected between the address pattern generator and the dynamic memory, the address scrambler connected to the non-volatile memory and configured to establish a hard wired logic relationship between the address and the scrambled address based on the address scrambling algorithm.

In one of the embodiments, the logic processor may further comprise a dynamic memory interface, through which the programmable logic array couples the scrambled address to the dynamic memory.

In one of the embodiments, the test information may comprise data, wherein the scrambling algorithm comprises a data scrambling algorithm, and the logic processor is configured to scramble the data based on the data scrambling algorithm and transmit the scrambled data to the dynamic memory.

In one of the embodiments, the logic processor may comprise: an address pattern generator for generating an address; a data pattern generator for generating the data; and a data scrambler comprising a first programmable logic array and a second programmable logic array. The first programmable logic array connects with the address pattern generator and the non-volatile memory, and is configured to establish a hard wired logic relationship between the address and scrambling factors based on the data scrambling algorithm, and output the scrambling factors, and the second programmable logic array connects the data pattern generator, the dynamic memory, and the first programmable logic array, and the second programmable logic array is configured to establish a hard wired logic relationship among the data, the scrambling factors, and the scrambled data based on the data scrambling algorithm.

In one of the embodiments, the logic processor may comprise a dynamic memory interface, through which the second programmable logic array forwards the scrambled data to the dynamic memory.

In one of the embodiments, the SiP assembly may comprise a system-on-chip (SoC) device including the non-volatile memory and the logic processor.

In one of the embodiments, the logic processor may comprise a plurality of non-volatile memory interfaces connected to the non-volatile memory, and the scrambling algorithm is read from the non-volatile memory through the plurality of non-volatile memory interfaces.

In one of the embodiments, the logic processor may comprise a plurality of dynamic memory interfaces connected to the dynamic memory, and the scrambled test information is transmitted to the dynamic memory through the plurality of dynamic memory interface.

In one of the embodiments, the non-volatile memory may comprise an electrically erasable programmable read-only memory (EEPROM).

In one of the embodiments, the dynamic memory may comprise a stack of a plurality of dynamic memory chips.

In one of the embodiments, the non-volatile memory is further configured to store a second scrambling algorithm for a second dynamic memory.

In another aspect, embodiments of the present invention discloses a method for testing a dynamic memory in a system-in-package (SiP) assembly, comprising: accessing, by a logic processor, a scrambling algorithm for the dynamic memory stored in a non-volatile memory; generating, by the logic processor, test information; scrambling, by the logic processor, the test information based on the scrambling algorithm; and transmitting, by the logic processor, the scrambled test information to the dynamic memory, wherein the dynamic memory, the non-volatile memory, and the logic processor are integrated and packaged in a single package.

The SiP assembly according the embodiments of the present invention can improve memory built-in self-test (MBIST) testing and enhance test qualities.

The summary is for illustration only and is not intended to be limiting in any sense. Besides the above illustrative aspects, embodiments and features, other aspects, embodiments and features will be obvious from the following detailed description with respect to the accompanying drawings.

### BRIEF DESCRIPTION OF THE DRAWINGS

Throughout the following accompanying drawings, same reference numerals indicate the same or analogous components or elements, unless otherwise specified. The following accompanying drawings may not be necessarily drawn to scale. It is to be understood that these drawings depict only several embodiments of the present invention and should not be considered as limitation of the scope thereof.

FIGS. 1A and 1B are schematics of a SiP assembly in prior art.

FIG. 1C is a schematic of a memory array of a memory device in prior art.

FIG. 2 is a schematic of a SiP assembly according to an embodiment of the present invention.

FIG. 3 is a schematic of a SiP assembly according to another embodiment of the present invention.

FIG. 4 is a schematic of a logic processor, a non-volatile memory, and a dynamic memory according to an embodiment of the present invention.

FIG. 5 is a schematic of a third programmable logic array according to an embodiment of the present invention.

FIG. 6A is a schematic of a first programmable logic array according to an embodiment of the present invention.

FIG. 6B is a schematic of a second programmable logic array according to an embodiment of the present invention.

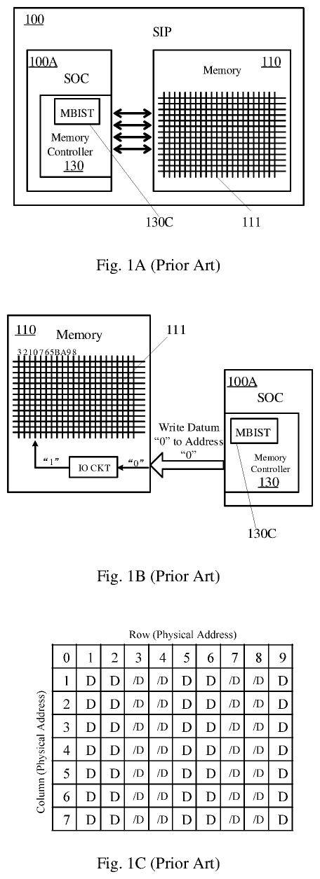

### LIST OF REFERENCE NUMERALS IN DRAWINGS

### Prior Art

100 SiP Assembly
100A SoC device
110 Memory
110 Memory Array
130 Memory Controller
130C MBIST System

### Embodiments of the Specification

200 SiP Assembly
200A SoC device
210 Dynamic Memory
220 Non-Volatile Memory
230 Logic Processor
230A Address Scrambler
230B Data Scrambler
230C MBIST Engine
231 Address Pattern Generator (ADD PG)
233 Data Pattern Generator (Data PG)
232 Third Programmable Logic Array
234 First Programmable Logic Array
235 Second Programmable Logic Array
236 Non-Volatile Memory Interface
237 Dynamic Memory Interface
S1, S2, S3 Wire
A1, A2, A3 Connection
234A First NAND Gate
234B Second NAND Gate
234C Inverter
235A XOR Gate
VCC1 First voltage port
VSS1 Second voltage port
VSS2 Third voltage port
VCC2 Fourth voltage port
VDD1 First Operating Voltage
VDD2 Second Operating Voltage
A[0:13] Address
D[0:7] Data
ADD[0:13] Scrambled Address
Data[0:7] Scrambled Data
300 SiP Assembly
300A SoC device

### DETAILED DESCRIPTION

Briefly described below are merely certain exemplary embodiments. As will be recognized by those skilled in the art, the embodiments disclosed herein may be modified in various manners without departing from the principle or scope of the invention. Accordingly, the accompanying drawings and description are exemplary but not constituting limitations of the specification.

The directional and spatial terms “central”, “longitudinal”, “transverse”, “lengthwise”, “widthwise”, “thickness-wise”, “upper”, “lower”, “front”, “rear”, “left”, “right”, “vertical”, “horizontal”, “top”, “bottom”, “interior”, “exterior”, “clockwise”, “counterclockwise”, “axial”, “radial”, “circumferential” and etc. are meant to be used with respect to the configurations shown in the figures. They are intended merely to facilitate and simplify the explanation of the specification and do not indicate or imply the devices or elements have to have, or be constructed or operated in, particular orientations. Therefore, they do not construct the limitation of the specification.

In addition, the terms “first”, “second” and etc. are used herein only for the purpose of illustration and do not indicate or imply importance or quantity of the elements. Therefore, a feature described with “first”, “second”, or the like can explicitly or implicitly indicate one or more of such features. As used herein, the term “plurality” has the meaning of “two or more”, unless the context clearly indicates otherwise.

Unless defined or limited otherwise, the terms “mounted” “coupled”, “connected”, “fixed” or any variant thereof, should be considered in a broad sense. For example, they might be a fixed connection, a detachable connection, an integration, a mechanical connection, electrical connection, or a communication. They might be directly connected or indirectly connected via an intermediate medium. They might be internal connection of two elements or interaction between two elements. For those of ordinary skill in the art, those terms can be interpreted with respect to their context.

In this specification, unless defined or limited otherwise, when a first feature is described as being “on” or “under” a second feature, the first feature can be in direct contact with the second feature, or the first feature and the second feature may be indirect contact via another feature presented therebetween. Moreover, when a first feature is described as being “over”, “overlying” or “above” a second feature, the first feature may either be right over or obliquely over the second feature, or the first feature may have a horizontal level higher than that of the second feature. When a first feature is described as being “under”, “underlying” or “beneath” a second feature, the first feature may either be right under or obliquely under the second feature, or the first feature may have a horizontal level lower than that of the second feature.

The following disclosure provides many different embodiments or examples for implementing different structures of the invention. Components and arrangements of specific examples are described below to simplify the present disclosure. These are, of course, merely examples and do not construct limitations. In addition, the present disclosure may repeat reference numerals and/or letters in the various examples. This repetition is for the purpose of simplicity and clarity and does not dictate a relationship between the various embodiments and/or configurations.

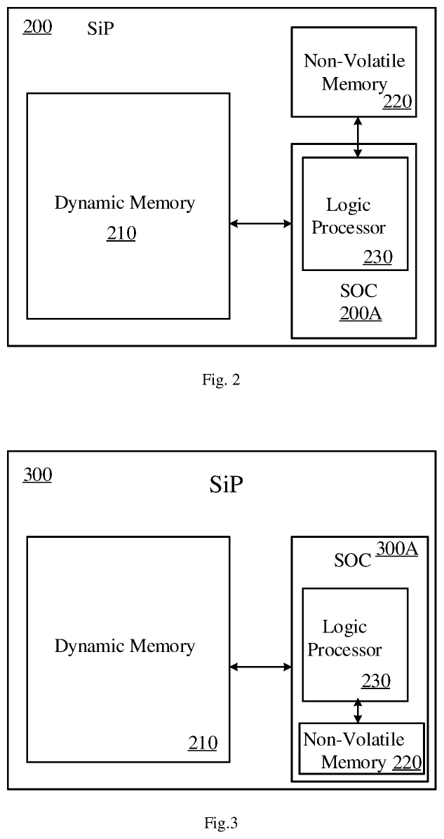

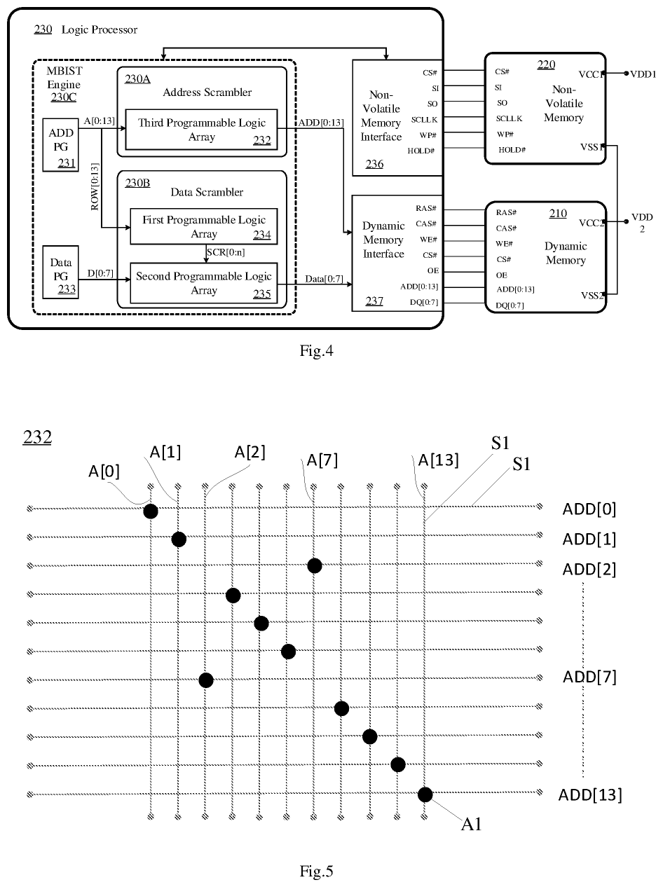

In order to provide a memory built-in self-test (MBIST) with diagnostics test patterns that can work with different memories from different manufacturers, a system-in-package (SiP) assembly 200 is provided according to an embodiment of the present invention. As shown in FIG. 2, the SiP assembly 200 includes a dynamic memory 210, a non-volatile memory 220, and a logic processor 230.

The dynamic memory 210 may be implemented by a dynamic random access memory (DRAM). The non-volatile memory 220 may be implemented by a programmable read-only memory (PROM), an erasable programmable read-only memory (EPROM), or a flash memory. Preferably, the non-volatile memory 220 may be an electrically erasable programmable read-only memory (EEPROM).

The dynamic memory 210 may be a stack of a plurality of dynamic memory chips that are vertically or horizontally (e.g., side by side) stacked or otherwise coupled together.

In this embodiment, the SiP assembly 200 may include a system-on-chip (SoC) device 200A embedded with a logic processor 230, which may be, for example, a controller for the dynamic memory 210 or a processor chip.

The dynamic memory 210 (or the multiple dynamic memory chips thereof) may be available from various manufacturers. That is, various scrambling algorithms including address scrambling algorithms and data scrambling algorithms can be suitable for the dynamic memory 210. The non-volatile memory 220 is configured to store a scrambling algorithm for the dynamic memory 210. The logic processor 230 is connected between the dynamic memory 210 and the non-volatile memory 220, and configured to generate test information, scramble the test information based on the scrambling algorithm stored in the non-volatile memory 220, and transmit the scrambled test information to the dynamic memory 210.

As shown in FIG. 3, in a SiP assembly 300 according to another embodiment of the present invention, the non-volatile memory 220 and the logic processor 230 are included in the SoC device 300A.

As shown in FIG. 4, the non-volatile memory 220 may have a first voltage port VCC1 connected to a first operating voltage VDD1, and a second voltage port VSS1 connected to a third voltage port VSS2 of the dynamic memory 210. The dynamic memory 210 may have a fourth voltage port VCC2 connected to a second operating voltage VDD2. In addition, the logic processor 230 may include a non-volatile memory interface 236 having various ports, e.g., CS#, SI, SO, SCLLK, WP#, and HOLD#, which are connected to corresponding ports of the non-volatile memory 220 for communications. The logic processor 230 may further include a dynamic memory interface 237 having various ports, e.g., RAS#, CAS#, WE#, CS#, OE, ADD[0:13], and DQ[0:7], which are connected to corresponding ports of the dynamic memory 210 for communications.

The above various ports of the interfaces are only exemplary. For example, the CS#, SI, SO, SCLLK, WP#, and HOLD# ports are suitable when the non-volatile memory 220 is implemented as an EEPROM. However, the non-volatile memory 220 may be implemented as memory of other types, and the ports of the interfaces may vary with respect to the type of the implemented non-volatile memory. As another example, the bits of the address and data of the dynamic memory 210 are not limited to the 14-bit (ADD[0:13]) and 8-bit (DQ[0:7]), respectively, and other numbers of bits can be also possible.

The test information generated by the logic processor 230 may include address, e.g., A[0:13]. The scrambling algorithm stored in the non-volatile memory 220 for the dynamic memory 210 may include an address scrambling algorithm. In the embodiment shown in FIG. 4, the logic processor 230 may include an address pattern generator (ADD PG) 231 for generating the address A[0:13] and an address scrambler 230A. The address scrambler 230A is connected to the ADD PG 231, the non-volatile memory 220 to read the address scrambling algorithm (e.g., via the non-volatile memory interface 236), and the dynamic memory 210 (e.g., via the dynamic memory interface 237). The address scrambler 230A may scramble the address A[0:13] based on the address scrambling algorithm to generate a scrambled address ADD[0:13]. The scrambled address ADD[0:13] is transmitted to the dynamic memory 210 (e.g., via the dynamic memory interface 237).

In the embodiment of FIGS. 4 and 5, preferably, the address scrambler 230A is a third programmable logic array 232 capable of establishing a hard wired logic relationship between the address A[0:13] and the scrambled address ADD[0:13] based on the address scrambling algorithm stored in the non-volatile memory 220. As shown in FIG. 5, the third programmable logic array 232 may include wires S1 for correlating the address A[0:13] to the scrambled address ADD[0:13]. For example, the address scrambling algorithm read from the non-volatile memory 220 may contain: ADD[0]=A[0]; ADD[1]=A[1]; ADD[2]=A[7]; ADD[3]=A[3]; ADD[4]=A[4]; ADD[5]=A[5]; ADD[6]=A[6]; ADD[7]=A[2]; ADD[8]=A[8]; ADD[9]=A[9]; ADD[10]=A[10]; ADD[11]=A[11]; ADD[12]=A[12]; ADD[13]=A[13]. The third programmable logic array 232 may be programmed to form connections A1 based on the address scrambling algorithm, to implement the algorithm's logic relationships in hardware. The input A[0:13] and output ADD[0:13] may have no logic relationship with each other before programming. After being programmed according to the above address scrambling algorithm, the third programmable logic arrays 232 may enable connections between the ADD[0] and A[0], ADD[1] and A[1], ADD[2] and A[7], ADD[3] and A[3], ADD[4] and A[4], ADD[5] and A[5], ADD[6] and A[6], ADD[7] and A[2], ADD[8] and A[8], ADD[9] and A[9], ADD[10] and A[10], ADD[11] and A[11], ADD[12] and A[12], ADD[13] and A[13] to establish the hard wired logic relationship between them.

The non-volatile memory 220 may be configured to store more than one scrambling algorithms for different types of dynamic memory or different manufacturers. When a different dynamic memory is packaged in the SiP, a different address scrambling algorithm may be used for testing. The programmable logic arrays 232 may be re-programmed to establish a different hard wired logic relationship (i.e., enable or disable different connections between the A[0:13] and ADD[0:13]) to implement the different scrambling algorithm. By using a programmable logic array 232 and storing multiple scrambling algorithms in the non-volatile memory 220, the logic processor has a flexibility to test different dynamic memories packaged in the SiP with corresponding scrambling algorithms.

In some embodiments, there are complex scrambling algorithms (e.g., address-based data scrambling algorithms) for the dynamic memory. The test information generated by the logic processor 230 may include data, e.g., D[0:7]. In this case, the scrambling algorithm stored in the non-volatile memory 220 for the dynamic memory 210 may be a data scrambling algorithm. Since the data scrambling algorithm is based on the addresses (e.g., usually on row addresses.) Thus, the data D[0:7] is typically scrambled by using the row address ROW[0:13] of the address A[0:13].

As shown in FIG. 4, the logic processor 230 may include a data pattern generator (Data PG) 233 for generating the data D[0:7]. The logic processor 230 may further include a data scrambler 230B which is connected to the ADD PG 231 to receive the row address ROW[0:13] and Data PG 233 to receive the data D[0:7]. The data scrambler 230B may also be connected to the non-volatile memory 220 to read the data scrambling algorithm via the non-volatile memory interface 236, and dynamic memory 210 via the dynamic memory interface 237. The data scrambler 230B may be configured to scramble the data D[0:7] to generate scrambled data Data[0:7] based on the data scrambling algorithm, and transmit the scrambled data Data[0:7] to the dynamic memory 210 via the dynamic memory interface 237.

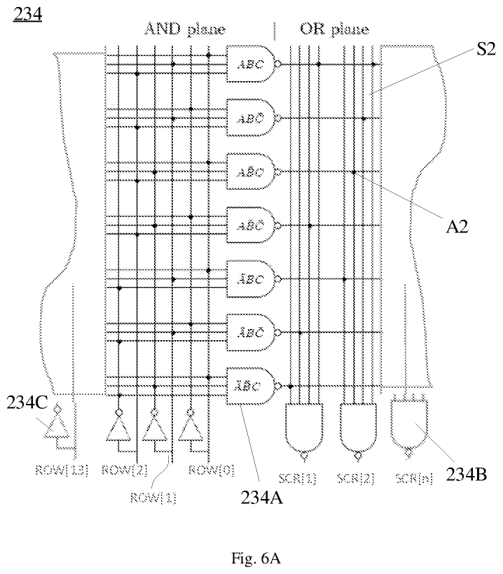

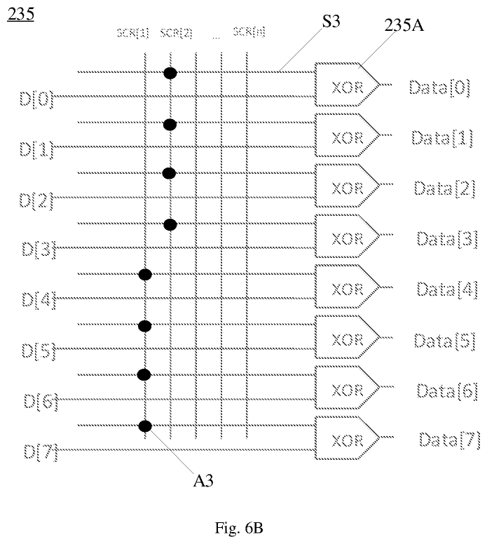

In some embodiments shown in FIGS. 4, 6A, and 6B, preferably, the data scrambler 230B may comprise a first programmable logic array 234 and a second programmable logic array 235.

As shown in FIG. 4, the first programmable logic array 234 may be connected between the ADD PG 231 and the second programmable logic array 235, and further to the non-volatile memory 220 via the non-volatile memory interface 236. The first programmable logic array 234 may be configured to establish a hard wired logic relationship between the row address ROW[0:13] and scrambling factors SCR[0:n] based on the data scrambling algorithm stored in the non-volatile memory 220.

As shown in FIG. 6A, the first programmable logic array 234 may include wires S2 and multiple logic gates to correlate the row address ROW[0:13] and the scrambling factors SCR[0:n]. The logic gates may comprise a logic AND plane, a logic OR plane, a plurality of first NAND gates 234A, a plurality of second NAND gates 234B, and a plurality of inverters 234C. For example, the data scrambling algorithm read from the non-volatile memory 220 may include:

SCR[1]=/ROW[0]./ROW[1].ROW[2]+/ROW[0].ROW[1]./ROW[2]+ROW[0]./ROW[1]./ROW[2]+ROW[0].ROW[1].ROW[2];

SCR[2]=/ROW[0].ROW[1].ROW[2]+ROW[0]./ROW[1].ROW[2]+ROW[0].ROW[1]./ROW[2]+ROW[0].ROW[1].ROW[2].

The first programmable logic array 234 may have multiple connections A2 formed based on the above algorithms, thereby implementing the algorithm's logic relationship in hardware.

Referring to FIG. 4, the second programmable logic array 235 may be connected between the first programmable logic array 234 and the dynamic memory 210 via the dynamic memory interface 237, and to the Data PG 233. The second programmable logic array 235 may be configured to establish a hard wired logic relationship among the scrambling factors SCR[0:n], the data D[0:7], and the scrambled data Data[0:7] based on the data scrambling algorithm read from the non-volatile memory 220.

Referring to FIG. 6B, the second programmable logic array 235 may include wires S3 and multiple logic XOR gates 235A to correlate the scrambling factors SCR[0:n], the data D[0:7], and the scrambled data Data[0:7]. For example, the data scrambling algorithm read from the non-volatile memory 220 may contain: Data[0:3]=D[0:3].XOR.SCR[2]; Data[4:7]=D[4:7].XOR.SCR[1]. The second programmable logic array 235 may comprise several connections A3 formed based on the above algorithms, to implement the algorithm's logic relationship in hardware.

It is to be noted that the bit count of the address A[0:13] is based on the address bits of ADD[0:13] of the dynamic memory 210, and the bit count of the data D[0:7] is based on the data bits of Data[0:7] of the dynamic memory 210. Therefore, bit count of the address A[0:13] and bit count of the data D[0:7] may vary depending on the bit counts of the dynamic memory 210.

According to another embodiment, the logic processor 230 may include a MBIST engine 230C for testing the dynamic memory 210. In this case, the address scrambler 230A, the data scrambler 230B, the ADD PG 231, and the Data PG 233 may be comprised in the MBIST engine 230C. According to connections between the MBIST engine 230C and the non-volatile memory 220, the address scrambler 230A can be connected to the non-volatile memory 220, and the data scrambler 230B can be connected to the non-volatile memory 220.

The SiP assembly 200 and the SiP assembly 300 in the embodiments of the present invention can store different scrambling algorithms in the non-volatile memory 220 with respect to different dynamic memories 210 to improve MBIST testing and enhance test qualities, such as accuracy and efficiency. Moreover, The SiP assembly 200 and the SiP assembly 300 can meet different MBIST testing requirements of different memories from different manufacturers.

Described above are merely some specific embodiments of the present invention. The scope of the present invention, however, is not limited to these disclosed embodiments and is intended to embrace all variants and substitutions derived by those of ordinary skill in the art in light of the teachings disclosed herein. Accordingly, the scope of the present invention is defined by the appended claims.

What is claimed is:

1. A system-in-package (SiP) assembly, comprising:
a dynamic memory;
a non-volatile memory configured to store a scrambling algorithm for the dynamic memory; and
a logic processor connected to the dynamic memory and the non-volatile memory, and the logic processor configured to generate test information, scramble the test information based on the scrambling algorithm stored in the non-volatile memory, and transmit the scrambled test information to the dynamic memory,
wherein the dynamic memory, the non-volatile memory, and the logic processor are integrated and packaged in a single package.

2. The SiP assembly of claim 1, wherein
the test information comprises an address,
the scrambling algorithm comprises an address scrambling algorithm, and
the logic processor is configured to scramble the address based on the address scrambling algorithm and transmit the scrambled address to the dynamic memory.

3. The SiP assembly of claim 2, wherein the logic processor comprises:
an address pattern generator for generating the address; and
an address scrambler comprising a programmable logic array connected between the address pattern generator and the dynamic memory, the address scrambler connected to the non-volatile memory and configured to establish a hard wired logic relationship between the address and the scrambled address based on the address scrambling algorithm.

4. The SiP assembly of claim 3, wherein the logic processor comprises a dynamic memory interface, through which the programmable logic array forwards the scrambled address to the dynamic memory.

5. The SiP assembly of claim 1, wherein
the test information comprises data,
the scrambling algorithm comprises a data scrambling algorithm, and
the logic processor is configured to scramble the data based on the data scrambling algorithm and transmit the scrambled data to the dynamic memory.

6. The SiP assembly of claim 5, wherein the logic processor comprises:
an address pattern generator for generating an address;
a data pattern generator for generating the data; and
a data scrambler comprising a first programmable logic array and a second programmable logic array, wherein the first programmable logic array connects with the address pattern generator and the non-volatile memory, and is configured to establish a hard wired logic relationship between the address and scrambling factors based on the data scrambling algorithm, and output the scrambling factors to the second programmable logic array,
wherein the second programmable logic array connects with the data pattern generator, the dynamic memory, and the first programmable logic array, and the second programmable logic array is configured to establish a hard wired logic relationship among the data, the scrambling factors, and the scrambled data based on the data scrambling algorithm.

7. The SiP assembly of claim 6, wherein the logic processor comprises a dynamic memory interface, through which the second programmable logic array forwards the scrambled data to the dynamic memory.

8. The SiP assembly of claim 1, wherein the SiP assembly comprises a system-on-chip (SoC) device including the non-volatile memory and the logic processor.

9. The SiP assembly of claim 1, wherein the logic processor comprises a plurality of non-volatile memory interfaces connected to the non-volatile memory, and the scrambling algorithm is accessed from the non-volatile memory through the plurality of non-volatile memory interfaces to the logic processor.

10. The SiP assembly of claim 1, wherein the logic processor comprises a plurality of dynamic memory interfaces connected to the dynamic memory, and the scrambled test information is forwarded from the logic processor to the dynamic memory through the plurality of dynamic memory interfaces.

11. The SiP assembly of claim 1, wherein the non-volatile memory comprises an electrically erasable programmable read-only memory.

12. The SiP assembly of claim 1, wherein the dynamic memory comprises a stack of a plurality of dynamic memory chips.

13. The SiP assembly of claim 1, wherein the non-volatile memory is further configured to store a second scrambling algorithm for a second dynamic memory, and the second dynamic memory is integrated and packaged in the single package.

14. A method for testing a dynamic memory in a system-in-package (SiP) assembly, comprising:
accessing, by a logic processor, a scrambling algorithm for the dynamic memory stored in a non-volatile memory;
generating, by the logic processor, test information;
scrambling, by the logic processor, the test information based on the scrambling algorithm; and
transmitting, by the logic processor, the scrambled test information to the dynamic memory,
wherein the dynamic memory, the non-volatile memory, and the logic processor are integrated and packaged in a single package.

15. The method of claim 14, wherein
the test information comprises an address,
the scrambling algorithm comprises an address scrambling algorithm, and
scrambling the test information includes scrambling the address based on the address scrambling algorithm and transmitting the scrambled address to the dynamic memory.

16. The method of claim 15, wherein the logic processor comprises an address pattern generator and an address scrambler, further comprising:
generating the address by the address pattern generator, wherein the address pattern generator is connected to the dynamic memory by a programmable logic array, and the programmable logic array is in the address scrambler; and
establishing a hard wired logic relationship between the address and the scrambled address based on the address scrambling algorithm.

17. The method of claim 16, further comprising:
forwarding the scrambled address to the dynamic memory through a dynamic memory interface, wherein the dynamic memory interface is in the logic processor.

18. The method of claim 14, wherein
the test information comprises data,
the scrambling algorithm comprises a data scrambling algorithm, and
scrambling the test information includes scrambling the data based on the data scrambling algorithm and transmitting the scrambled data to the dynamic memory.

19. The method of claim 18, wherein the logic processor comprises an address pattern generator, a data pattern generator and a data scrambler, further comprising:
generating an address by the address pattern generator;
generating the data by the data pattern generator;
establishing a hard wired logic relationship between the address and scrambling factors based on the data scrambling algorithm and outputting the scrambling factors by a first programmable logic array to a second programmable logic array, wherein the first programmable logic array and the second programmable logic array are in the data scrambler, the first programmable logic array connects with the address pattern generator and the non-volatile memory; and
establishing a hard wired logic relationship among the data, the scrambling factors, and the scrambled data based on the data scrambling algorithm by the second programmable logic array, wherein the second programmable logic array connects with the data pattern generator, the dynamic memory, and the first programmable logic array.

20. The method of claim 14, further comprising:
accessing, by the logic processor, a second scrambling algorithm for a second dynamic memory stored in a non-volatile memory;
generating, by the logic processor, second test information;
scrambling, by the logic processor, the second test information based on the second scrambling algorithm; and
transmitting, by the logic processor, the scrambled test information to the second dynamic memory,
wherein the second dynamic memory is integrated and packaged in the single package.
